(19) United States
(12) Patent Application Publication
(10) Pub. No.: US 2017/0231169 A1
(43) Pub. Date: Aug. 17, 2017

(54) Growing System

(71) Applicant: Steratec Limited, Maidstone Kent (GB)

(72) Inventors: Martin Gillard, Maidstone Kent (GB); David Burdett-Brown, Maidstone Kent (GB); Bill Dunster, Maidstone Kent (GB)

(73) Assignee: Steratec Limited, Maidstone Kent (GB)

(21) Appl. No.: 15/502,593

(22) PCT Filed: Aug. 8, 2014
(86) PCT No.: PCT/GB2014/052441

§ 371 Date: Feb. 8, 2017

(30) Foreign Application Priority Data
Aug. 8, 2013 (GB) 1314218.7

(51) Int. Cl. A01G 9/14; A01G 9/24

(52) U.S. Cl. CPC A01G 9/1415; A01G 9/24

(57) ABSTRACT

A growing room for providing a controlled growing environment comprises a thermally insulated, light-transmissive inner enclosure (8) for containing the controlled growing environment (4). The inner enclosure 8 encloses, in use, a controlled atmosphere for the controlled growing environment (4). A light-transmissive outer enclosure 6 surrounds the inner enclosure (8) and is arranged to protect the inner enclosure (8) from the external environment, in use. A ventilated cavity (10) is defined between the out er enclosure (6) and inner enclosure (8). The outer enclosure (6) has at least one lower ventilation opening (11) and at least one upper ventilation opening (12) for allowing controlled ventilation of the ventilated cavity (10). A radiation control layer is located in the ventilated cavity (10) between the outer enclosure (6) and the inner enclosure (8) and is arranged to provide controlled absorption of incident solar radiation, whereby to control the level of solar radiation within the controlled growing environment (4).

This invention relates to a growing system for growing various types of produce in a controlled environment so that the produce is protected from damage by external environmental factors.

### BACKGROUND

Growing rooms, for example of the type disclosed in EP1439747B1are known. The growing room described therein is designed to enable produce to be grown throughout the year in temperate climate regions, regardless of season and the outside environmental conditions. In temperate conditions, this is achieved by the provision of a room constructed with a double skin structure wherein air from outside can be circulated between the two skin layers to help maintain an evenly distributed temperature throughout the whole growing room. It is advantageous to have the interior of the growing room substantially totally sealed from the outside and this is achieved by allowing access to the growing room only through end rooms attached thereto and by having positive air pressure inside the growing room itself.

Despite the advantages of the above described growing room, it may not offer sufficient control of the growing environment when the growing room is located in extremely hot locations or extremely bright locations. In the Middle East, for example, where there is substantial incident solar radiation on the growing room, too much heat and/or light may enter the growing room, adversely affecting the produce. There is therefore a need for a growing room with improved environmental control and specifically designed to function effectively throughout the year in both temperate and extreme climate conditions. Desirably, the improved growing room may also reduce its electrical and thermal loads to minimise the cost of meeting its energy requirements.

Furthermore, the above described growing room may not be robust enough to survive for a long period of time (twenty years) in a desert environment with high insolation, high UV, high relative humidity, sandstorms, flash flooding and high winds with low maintenance. Therefore an improved growing room may exhibit improved robustness to the environmental conditions experienced throughout the year in both temperate and extreme climate conditions.

### BRIEF SUMMARY OF THE DISCLOSURE

The invention is defined in the appended claims. In accordance with a first aspect of the present invention there is provided a growing room for providing a controlled growing environment. The room comprises a thermally insulated, light-transmissive inner enclosure for containing the controlled growing environment. The inner enclosure encloses, in use, a controlled atmosphere for the controlled growing environment. A light-transmissive outer enclosure surrounds the inner enclosure and is arranged to protect the inner enclosure from the external environment, in use. A ventilated cavity is defined between the outer enclosure and inner enclosure, the outer enclosure having defined therein at least one lower ventilation opening and at least one upper ventilation opening for allowing controlled ventilation of the ventilated cavity. A radiation control layer is located in the ventilated cavity between the outer enclosure and the inner enclosure and arranged to provide controlled absorption of incident solar radiation, whereby to control the level of solar radiation within the controlled growing environment.

Thus, in accordance with the present invention, the level of solar radiation entering the controlled growing environment is controlled by the radiation control layer. The controlled atmosphere in the controlled growing environment advantageously allows the temperature, humidity and composition of the atmosphere within the controlled growing environment to be independent of the atmosphere within the ventilated cavity. Cooling of the controlled growing environment can be achieved by ventilation of the ventilated cavity. Furthermore, the construction of the outer enclosure need be determined only by the requirement to protect the inner enclosure. By decoupling the ventilation of the growing room to atmosphere from the control of the incident solar radiation improved control over the controlled growing environment can be achieved. The improved control over the controlled growing environment can facilitate reduced electrical and thermal loads of the growing room.

The controlled atmosphere may be enriched with carbon dioxide. Source of carbon dioxide may be canisters of carbon dioxide. More preferably, the source of carbon dioxide is a carbon dioxide-rich atmosphere generated by a mushroom house. The controlled atmosphere may preferably contain between 300-900 ppm of carbon dioxide. More preferably the controlled atmosphere may contain between 600-900 ppm of carbon dioxide.

Plants consume more carbon dioxide at higher light levels and also at a higher atmospheric carbon dioxide level. Increasing the carbon dioxide content of the atmosphere from the typical ambient level of 330 ppm to between 600-900 ppm leads to increased carbon dioxide uptake by plants by up to 40%. The effect of carbon dioxide enrichment on crop yield is proportional to the amount and the time duration of carbon dioxide enrichment.

The benefits of carbon dioxide enrichment do not increase beyond 1000 ppm, so this is unnecessarily expensive, and some sensitive plants may be damaged by carbon dioxide levels in excess of 700 ppm.

The radiation control layer may comprise a first variable shading system arranged to shade a variable proportion of the outer surface of the inner enclosure. A second variable shading system may be provided outside the outer enclosure and be arranged to shade a variable proportion of the outer surface of the outer enclosure, whereby to provide controlled absorption of incident solar radiation. In this way, the first variable shading system can be formed of more fragile material than the second shading system which is exposed to a potentially harsh external environment.

The first and/or second variable shading system may comprise a blind assembly, preferably a roller blind assembly. Other blind assemblies may be used, for example louver blinds or solar electric panels that can rotate in position to adjust levels of insolation to the coolbox.

In general, the at least one upper ventilation opening and the at least one lower ventilation opening of the outer enclosure are openable for ventilation to the external atmosphere.

The at least one upper ventilation opening and the at least one lower ventilation opening may be provided with a mesh across their openings. The holes in the mesh may be smaller than 1 mm across at their widest part. More preferably, the holes are smaller than 100 pm across at their widest part.

Thus, the fine mesh is arranged to prevent the ingress of insects and windblown sand, or anything larger, into the outer enclosure from the outside environment, and provide little resistance to the movement of air through the mesh. The mesh is durable, to keep out insects, windblown sand, birds and vermin for the lifetime of the growing room (at least 20 years). The benefit of stopping insect ingress inside the inner coolbox sterile growing environment is that levels of pesticide and insecticide chemicals can be reduced or removed,—reducing the levels of chemical contamination in human food.

The inner enclosure may comprise a floor for the controlled growing environment and the floor may comprise an underfloor radiant temperature control system, in particular an underfloor radiant cooling system or an underfloor radiant heating system. The underfloor radiant temperature control system may provide background base heating and/or cooling. A condensate collection system may be provided for collecting condensate generated within the ventilated cavity and/or the inner enclosure for re-use. The condensate collection system may collect water condensing on the outer surface of the inner enclosure.

The growing room may comprise a dehumidifier in fluid communication with the inner enclosure. Preferably, the dehumidifier uses a liquid desiccant unit. The water from the dehumidifier may be recovered for reuse within the cultivation process.

The growing room may comprise a humidifier in fluid communication with the inner enclosure. Preferably, the humidifier is a spray humidifier, located within the inner enclosure.

The growing room may comprise a source of heat or coolth for thermal energy transfer to/from the controlled atmosphere. For cooling, preferably the source of coolth is chilled water. The chilled water may come from a chiller located outside the inner enclosure.

The outer enclosure may be constructed from an outer skin and an inner skin, wherein the inner skin is supported on the interior side of at least one structural member and the outer skin is supported on the exterior side of said at least one structural member and the at least one structural member includes a hole to allow air in the space between the inner and outer skins to flow from one side of the at least one structural member to the other. The inner skin may substantially seal the ventilated cavity from the space between the inner skin and the outer skin. The inner enclosure may be suspended from a structural frame located within the ventilated cavity.

The invention extends to a network of growing rooms. The network may include a plenum for the transmission of carbon dioxide between the controlled growing environments of the growing rooms in the network. The network may comprise a mushroom house in fluid communication with the growing rooms via the plenum. The mushroom house may be used to provide some or all of the carbon dioxide required for the controlled growing environments.

This is in itself believed to be novel and thus from a further aspect the invention provides a network of growing rooms, each growing room for providing a controlled sterile and insect proofed growing environment and comprising an enclosure for containing the controlled growing environment, the enclosure enclosing, in use, a controlled atmosphere for the controlled growing environment, the network including a plenum for the transmission of carbon dioxide between the controlled growing environments of the growing rooms in the network, wherein at least one, but not all, of the growing rooms in the network, is a mushroom house.

The network may include at least one service room, for example a packing house, in fluid communication with the controlled growing environments of the growing rooms. The service room may have a roof and the roof may be provided with solar panels for providing electrical power to the network.

The rooms in the network may be connected by corridors which are in fluid communication with the controlled growing environments of the growing rooms. In this way, the atmosphere within the entire network may be controlled continuously. This also enables secure access and crop transfer within the rooms in the network.

The invention further extends to a kit of parts for constructing the growing rooms of the first aspect of the present invention.

Thus, the present invention provides a growing room, network of growing rooms, or kit of parts for a growing room, suitable for producing food crops in a range of climates. These climates may include the extreme desert environment of coastal Oman, the humid and hot centre of Nigeria, or the temperate, humid climate of south England.

The present invention allows for operation using commonly available fossil fuels or renewable energy sources. The reduced heating, cooling and electric demands of the growing room according to the present invention, compared to a conventional greenhouse maintained at the same internal conditions, make it viable to power the growing room from solar energy in hot climates.

The growing systems used within the growing room in accordance with the present invention may be any of the commercial horticultural sector, including, but not limited to, nutrient film technique crops, for example grown in plastics gutters and vine crops, for example grown on suspended gutters using irrigation supply lines.

The collection and reuse (following filtration and sterilisation) of the drain water from the irrigation is also possible.

### BRIEF DESCRIPTION OF THE DRAWINGS

Embodiments of the invention are further described hereinafter, by way of example only, with reference to the accompanying drawings, in which:

FIG. 1 is a diagrammatic view of a growing room according to an embodiment of the present invention;

FIG. 2 is a cross-sectional view of a growing room according to an embodiment of the invention;

FIG. 3 is a schematic view of the growing room of FIG. 2 showing detail of the ventilation systems;

FIG. 4 is a schematic view of a network of growing rooms, showing the shared corridor;

FIG. 5 is a schematic view of a growing room indicating air flow;

FIG. 6 is a cross-sectional view of a growing room indicating shading and airflow; and

FIG. 7 is a diagrammatic view of a growing room showing detail of the controlled atmosphere modification system in the inner enclosure.

### DETAILED DESCRIPTION

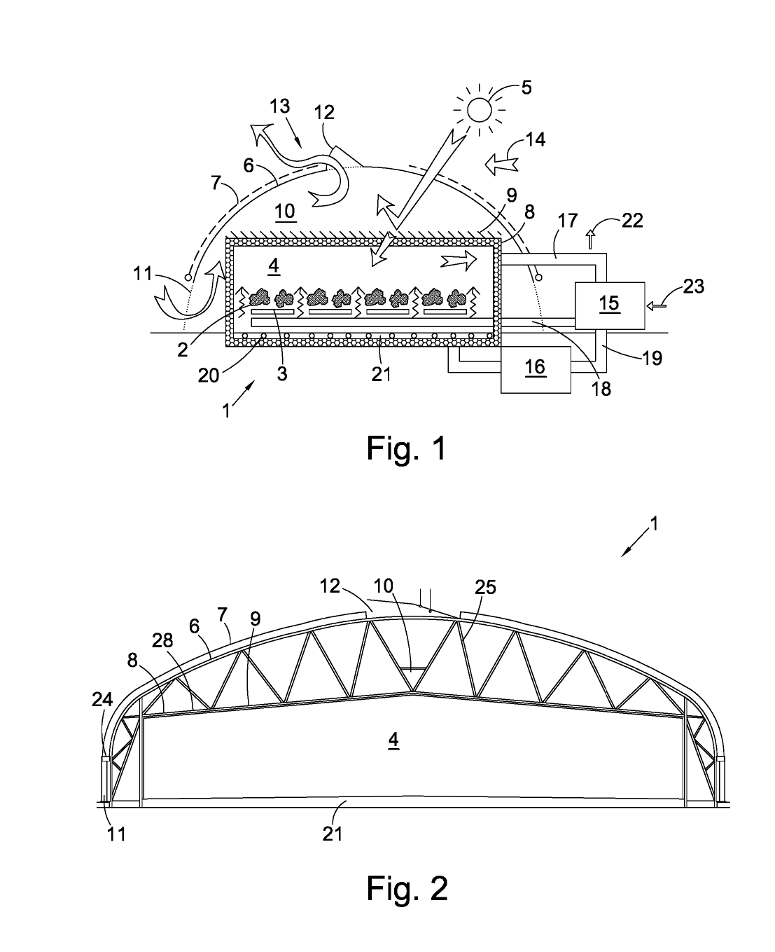

FIG. 1 shows a diagrammatic view of a growing room 1 according to one embodiment of the present invention. The growing room 1 can be used to grow all manner of produce. Ideally, the produce 2 is grown using Nutrient Film Technique (NFT), provided in gutters 3 beneath the produce. It is also be possible to grow produce using other techniques known to the commercial horticulturalist in a controlled growing environment 4 provided by the growing room 1.

Electromagnetic radiation from the sun 5 penetrates an outer enclosure 6 which is provided with an outer variable shading system 7 on the exterior surface thereof. The outer enclosure has a sloping roof and is light-transmissive.

A portion of the electromagnetic radiation penetrating the outer enclosure 6 also penetrates the inner enclosure 8. The inner enclosure is thermally insulated and light-transmissive. An inner variable shading system 9 is provided on the outer surface of the inner enclosure.

The region between the outer enclosure 6 and the inner enclosure 8 is a ventilated cavity 10. The electromagnetic radiation from the sun serves to increase the temperature of the air within the ventilated cavity relative to the air outside. Ventilation is provided by a lower vent 11 through which cooler air enters the ventilated cavity, and an upper vent 12 through which warmer air exits the ventilated cavity. This ventilation serves to cool the ventilated cavity 10.

The upper vent 12 is selectively openable on one side or the other such that there is a negative pressure region 13 located adjacent to the upper vent, due to the wind from the prevailing wind direction 14. This serves to draw air out of the ventilated cavity 10 through the upper vent 12. This lost air is replaced by cooler air entering the ventilated cavity 10 through the lower vent 11. In the case of a calm day with negligible wind, convection currents will cause the hot air to rise and exit out of the ventilated cavity 10, drawing in cooler air through the lower vent 11.

The region within the inner enclosure 8 provides the controlled growing environment 4. This is substantially sealed from the ventilated cavity 10 and the outside atmosphere. The thermal insulation of the inner enclosure 8 ensures that heating is kept to an acceptable level. The inner and outer variable shading systems 9, 7 further control the heating and light levels within the controlled growing environment 4 by restricting the proportion of electromagnetic radiation penetrating the inner enclosure 8.

Since the controlled growing environment 4 is substantially sealed, the composition of the atmosphere within the controlled growing environment can be optimised to promote growth of the produce 2. Increased carbon dioxide levels are provided in the controlled growing environment 4.

To help achieve the optimum growing conditions, a humidity modifier 15 may be provided and/or a source of heat or coolth 16. An air path 17 leads into the humidity modifier 15. Air with the desired humidity is then fed back to the produce along a second air path 18. The humidity modifier 15 can be a humidifier or a dehumidifier. In the case of a dehumidifier, waste water 19 from the dehumidifier unit can be passed to a source of heat or coolth. The waste water could also be used for irrigation.

A heat exchanger may be provided to transfer the thermal energy to/from the waste water. The water is then passed through pipes 20 embedded in a concrete floor 21 below the controlled growing environment 4 to heat or cool the controlled growing environment as required.

Small amounts of air transfer 22, 23 between the controlled growing environment and the outside atmosphere may occur if it would be more energy efficient to use external air and modify the composition and conditions than to modify the composition and conditions of air already present within the controlled growing environment.

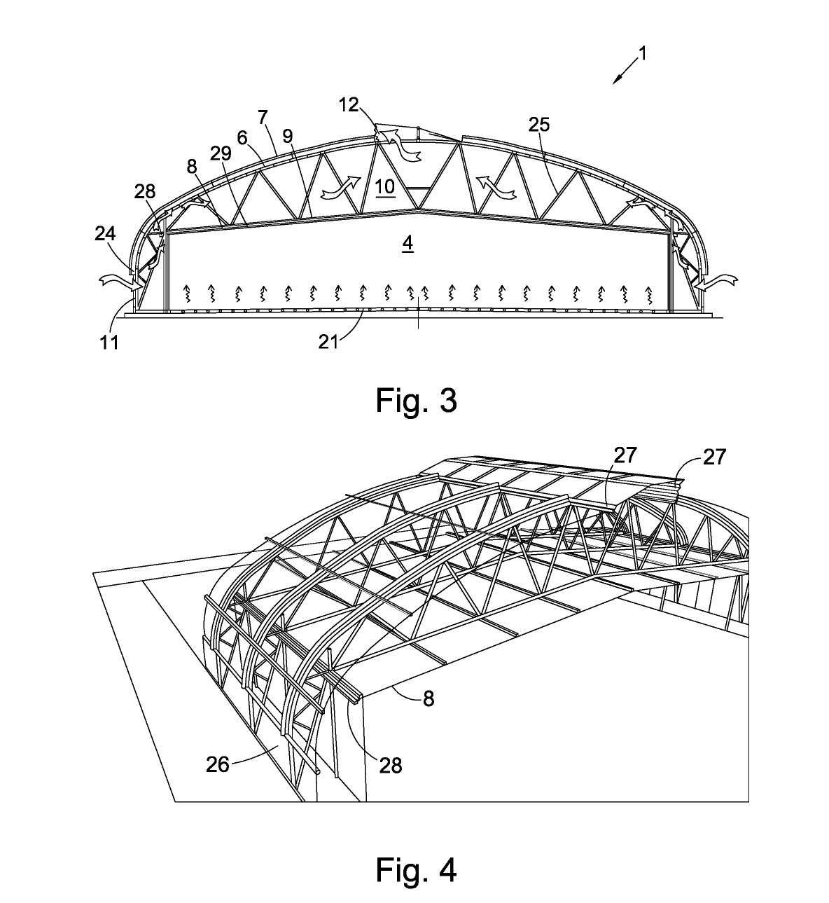

FIGS. 2 to 5 show detail of an embodiment of a growing according to the present invention. FIG. 2 is a cross-sectional view of the growing room 1. There is provided an outer enclosure 6 having a sloping roof. The outer enclosure 6 is preferably substantially transparent and provided with an outer shading system 7 on the exterior surface thereof. The outer shading system 7 is, in this example, an arrangement of external blinds which are retractable to cover at least part of the exterior surface of the outer enclosure, up to total coverage, depending on what is required by the climate conditions. The outer shading system 7 provides coarse or broad-brush control of the environment inside the growing room such as is needed according to the season and general weather conditions of the external environment, while allowing in sufficient light for crop growth.

The outer enclosure 6 is selectively ventilated so that air can circulate therein and this is achieved by providing openings in the roof 12 (e.g. at the uppermost ridge) and at the base 11 (near ground level) which can be selectively opened to the external environment.

The openings in the roof can be in the form of a ridge vent 12 designed so that one facet opens to create negative pressure whatever the prevailing wind direction. This will suck hot air out of the top of the outer enclosure 11, and may be automated to open and close to control airflow.

The openings at the base 11 can be in the form of a roll up vent 24. These can be automated to open and close to control airflow. Other types of vent may be used where these allow effective selective ventilation of the outer enclosure 6.

The outer enclosure 6 may be constructed from an outer skin and an inner skin mounted on either side of structural members 25, as described in EP1439747B1 (and in particular, shown in FIG. 4 of that patent) and in which air can circulate between the outer and inner skins to further facilitate cooling.

The outer enclosure 6 is preferably made from ETFE foil due to improved UV performance and enhanced life expectancy compared to polythene. The surface could also be replaced by glass or other light-transmissive greenhouse cladding materials if deemed appropriate.

The surface of the outer enclosure 6 is normally curved to enable simple ETFE skin tensioning devices to achieve a high surface tension to minimise flapping or mechanical vibration of the skin, which can cause premature failure of the cladding. The surface may also be flat panels or another shape if deemed appropriate.

The outer shading system 7 may be made from durable UV stabilised polyethylene or aluminised polyester windbreak material, capable of withstanding extreme weather conditions (including abrasion by sand) according to the location of the growing room 1. Fine mesh filters 26, 27 stop insects and windblown sand from entering the outer enclosure at both the base and the ridge.

Even in winter, in some climates, the sunlight can be strong enough to damage the growing produce, even with the outer shading system 7 in operation. In order to optimise yield, very precise environmental conditions (in terms of temperature, light levels etc) are required and these optimal conditions will change according to the different types of produce being grown in the growing room. Fine control of the environmental conditions is not readily achievable with only the coarse environmental control provided by the outer shading system 7 alone. In extreme climate conditions, many crops simply cannot be grown without suitable protection from incident solar radiation.

Therefore, in the growing system described herein, the controlled growing environment 4 in which the produce is grown is sealed inside a generally cuboid, multiple translucent glazed skin inner enclosure 8 provided inside the outer enclosure 6. This glazed skin can be made from polycarbonate, or multiple levels of ETFE, or translucent fibreglass, or cellular polyethylene or aerogel based glass products or any other translucent material with a higher resistance to thermal transmission than a single sheet of glass. There is a ventilated cavity 10 between the outer and inner enclosures. The inner enclosure 8 is normally sealed from both the ventilated cavity 10 and the external environment so that it contains a substantially closed growing environment 4 for the produce wherein the environmental conditions can be finely controlled. For example, the growing environment inside the inner enclosure 8 may have very high levels of CO₂ (as compared with the ventilated cavity) to encourage plant growth. In particular, the air exchange rate in the inner enclosure 8 is very low (as compared with the ventilated cavity 10)

In hot, humid environments, high humidity could cause condensation to occur on the outer surface of the inner enclosure 8. This can be a valuable source of fresh water from ambient air in desert environments. Gutters 28 may be provided to collect this water. The water may be used for crop irrigation, or other uses.

The inner enclosure 8 includes an envelope containing the controlled growing environment 4, and this envelope may be suspended from a structural frame 25 located within the ventilated cavity 10 inside the outer enclosure 6. The envelope is thermally insulated, and preferably translucent. The envelope is typically dimensioned to exactly fit the crop height requirements to avoid unnecessary cooling or heating of high internal volumes. An incident thermal radiation control layer is located between the outer enclosure 6 and the inner enclosure 8. This layer controls the extent to which incident thermal radiation penetrates to the crops in the controlled growing environment 4. Fine environmental control of the inner enclosure 8 (as compared with the relatively coarse environmental control of the outer enclosure 6 and ventilated cavity 10) can be achieved by means of an inner shading system 9, which forms the radiation control layer and is mounted on the exterior surface of the inner enclosure 8. The inner shading system 9 may be any retractable blind arrangement. Such a shading system requires access to motors and retractable blinds for cleaning and maintenance which might have a detrimental effect on the produce if the shading system was located within the controlled growing environment 4 (as would be the case if an inner shading system 9 were provided on the interior surface of a conventional growing room such as that described in EP1439747). Furthermore, the absorption of incident radiation by the shading system generates heat, which would increase the temperature of the controlled growing environment 4. The invention described herein is advantageous in that the inner shading system 9 is not located within the controlled growing environment 4 (inside the sealed inner enclosure) but is located on the exterior surface thereof, within the ventilated cavity 10. The ventilated cavity 10 is already potentially open to the external environment and therefore access to the inner shading system 9 for maintenance is not disadvantageous.

The inner shading system 9 may be computer controlled to allow for constant adjustment in response to the conditions inside the inner enclosure 8. Since the inner shading system 9 is protected from the external environment by the outer enclosure 6, its blinds or shades may be made from a more delicate, highly reflective material which would not be sufficiently durable if placed in the external environment. Heat gain caused by incident solar radiation falling on the blind surface is removed by the strong airflow within the ventilated cavity.

Supplementary light may be provided to the interior of the inner enclosure 8 by lights located outside the inner enclosure. This ensures that any heating load due to the lights is not adding to any cooling load required in the controlled growing environment 4. The lights may be LEDs to minimise this additional heating. The supplementary light will be provided in climates where there is insufficient ambient lighting for the growing conditions required.

The floor 21 of the inner enclosure 8 can be a concrete base including an underfloor radiant cooling system. The roof 29 of the inner enclosure 8 may be slightly sloped in order that any condensation forming on the inner surface thereon can run off rather than dripping onto the growing produce. Such condensation can be collected and used via a heat exchanger to further contribute to the cooling of the growing environment. The floor 21 may instead be made from stabilised aggregate or even soil. A layer of insulation beneath the floor prevents heat or coolth loss to the ground.

Conventional growing rooms use the same airspace as the crops to cool the internal air volume. In very hot climates, in order to provide sufficient cooling, a high air exchange rate in the airspace is required. Not only is there a disadvantage in the power consumption required for a high cooling load, but it is also more difficult to maintain the desired high level of CO₂ in the growing environment and to control humidity.

The growing room of the present invention has a very low air exchange rate in the growing environment, this being possible because of the sealed inner enclosure 8. Conditioning of the inner enclosure environment can be tailored specifically to the needs of the crops therein. This enables substantially improved environmental control of the growing environment in terms of heat, coolth, humidity, CO₂ level etc.

Conditioning of the ventilated cavity 10 can be tailored specifically to the needs of the external climate and the air exchange rate within the ventilated cavity 10 can be relatively high since this has no impact on the conditioned growing environment for the crops. A very significant reduction in overall heating/cooling costs can be made as compared with conventional growing rooms.

Using the same basic configuration (outer enclosure 6, sealed inner enclosure 8, ventilated cavity 10 and thermal radiation control layer), the growing room can be readily adapted for use in different climate conditions. Optional features (e.g. outer 7 and inner shading systems 9, thickness of the radiation control layer, ventilation 11, 12 of the outer enclosure 6 to the external environment, underfloor heating/cooling, condensation collection, humidity control etc) can be added or omitted depending upon the requirements of that climate, making the growing room suitable for use in virtually any climate.

Humidity control and heating/cooling can be performed within the inner enclosure 8. Alternatively, these functions can be performed as part of a circulating loop for the air in the inner enclosure, in addition to the insertion of a small amount of fresh air from outside the inner enclosure. This is now a realistic option for a greenhouse because the air within the growing space has a reduced air exchange rate. This makes cooling economic in hotter climates.

A number of the growing rooms as described above can be connected together into a network as shown in FIGS. 6 and 74. One end of each growing room 1 is connected to a shared corridor 30. The controlled growing environment 4 of each growing room may be kept at a positive air pressure (relative to the adjacent ventilated cavity 10 and shared corridor 30) to minimise ingress of contaminants when access to the inner enclosure 8 is required.

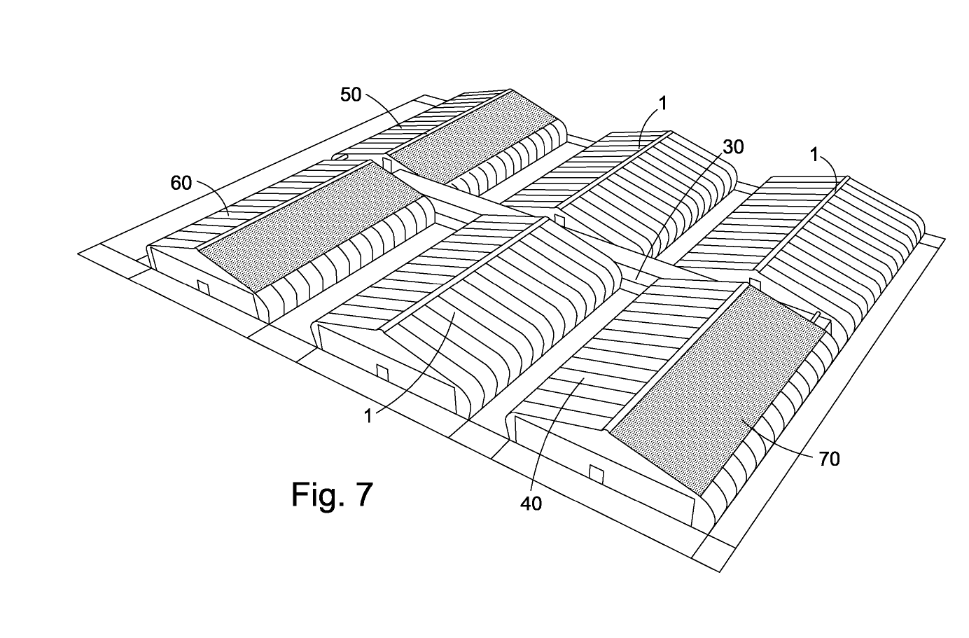

Growing mushrooms produces a large amount of CO₂, which could be used to improve the growing environment in the growing rooms described above. As illustrated in FIG. 7, a mushroom house 40 can be provided as part of the network. In practice, one mushroom house might produce enough CO₂ for up to fifteen growing rooms.

There is also provided at least one packing house 50 and a storage facility 60, also connected together by the shared corridor 30. Any or all of the mushroom house, the packing house and the storage facility can be provided with solar roof panels 70 for generation of electricity that can contribute to the electrical power required on site.

The shared corridor 30 is provided with a plenum in the form of a high level fabric duct in which CO₂ rich air from the mushroom house 40 can be transmitted to the growing rooms 1 in the network. Computerised monitoring and control of the CO₂ levels can be provided. The roof of the shared corridor 30 provides service access to the ventilated cavities 10 of the growing rooms 1 for maintenance. Access to the roof of the shared corridor is by way of a staircase in the packing house 50.

An intermediate corridor 80 can be provided between two adjacent growing rooms 1. The intermediate corridor is substantially perpendicular to the shared corridor 30 and is not connected thereto. Optionally, the intermediate corridor can support at least part of the outer shading system 7.

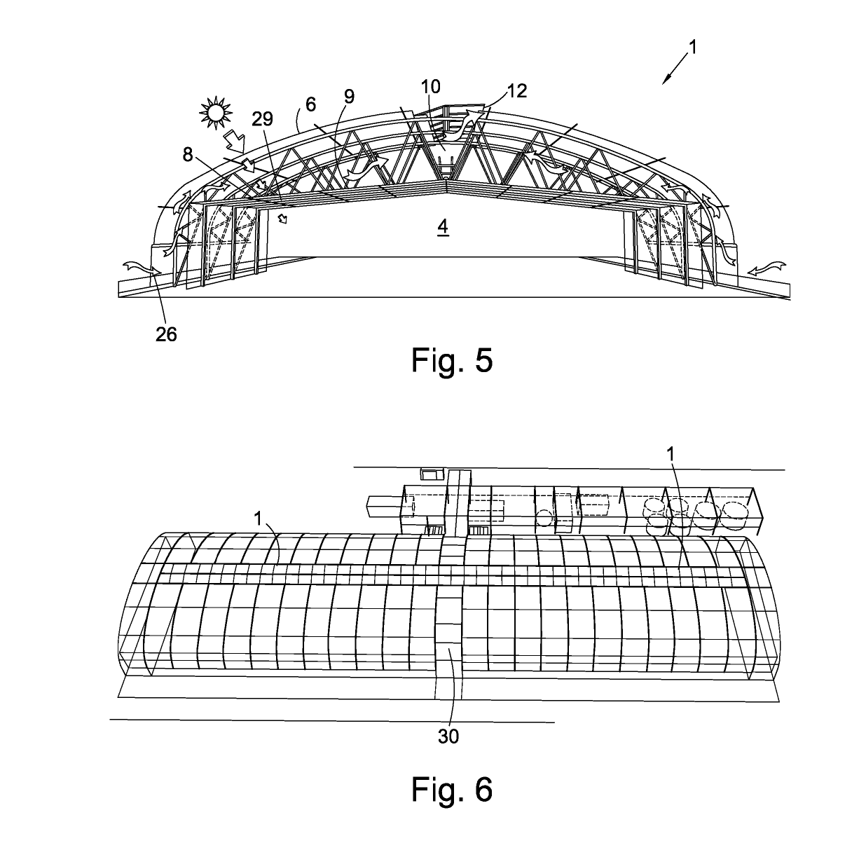

FIG. 5 is a cross-sectional view of a growing room 1 indicating air flow,. Outside air from the external environment enters the ventilated cavity 10 of the growing room 1 through a mesh filter 26. The air is free to circulate within the ventilated cavity 10, travelling up and over the sealed inner enclosure 8. Air can exit the ventilated cavity 10 at a ridge vent 12 at the top of the outer enclosure 6. There is a relatively high rate of change of the air in the ventilated cavity 10 so as to provide a substantial coarse cooling effect on the inner enclosure 8.

The inner shading system 9 provides fine control of the growing environment in the inner enclosure 8.

CO₂ from the mushroom house 40 can be delivered (via the plenum) to supply ducts under the produce growing trays in the inner enclosure 8.

The growing rooms, mushroom house, packing house and storage facility can each be realised by way of common outer enclosures, with the inner enclosure and/or other features provided therein depending on the desired type of room. A modular arrangement of outer enclosures could be provided to facilitate the construction of networks of numerous rooms.

In summary, a growing room for providing a controlled growing environment comprises a thermally insulated, light-transmissive inner enclosure 8 for containing the controlled growing environment 4. The inner enclosure 8 encloses, in use, a controlled atmosphere for the controlled growing environment 4. A light-transmissive outer enclosure 6 surrounds the inner enclosure 8 and is arranged to protect the inner enclosure 8 from the external environment, in use. A ventilated cavity 10 is defined between the outer enclosure 6 and inner enclosure 8. The outer enclosure 6 has at least one lower ventilation opening 11 and at least one upper ventilation opening 12 for allowing controlled ventilation of the ventilated cavity 10. A radiation control layer is located in the ventilated cavity 10 between the outer enclosure 6 and the inner enclosure 8 and is arranged to provide controlled absorption of incident solar radiation, whereby to control the level of solar radiation within the controlled growing environment 4.

Crops can be grown in this controlled environment throughout the year and the quality and volume of outputs is improved compared to conventional growing systems, even in extreme climatic conditions.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A growing room for providing a controlled growing environment, the room comprising:
a thermally insulated, light-transmissive inner enclosure for containing the controlled growing environment, the inner enclosure enclosing, in use, a controlled atmosphere for the controlled growing environment;
a light-transmissive outer enclosure surrounding the inner enclosure and arranged to protect the inner enclosure from the external environment, in use;
a ventilated cavity defined between the outer enclosure and inner enclosure, the outer enclosure having defined therein at least one lower ventilation opening and at least one upper ventilation opening for allowing controlled ventilation of the ventilated cavity; and
a radiation control layer located in the ventilated cavity between the outer enclosure and the inner enclosure and arranged to provide controlled absorption of incident solar radiation, whereby to control the level of solar radiation within the controlled growing environment.

2. The growing room of claim 1, wherein the radiation control layer comprises a first variable shading system arranged to shade a variable proportion of the outer surface of the inner enclosure.

3. The growing room of claim 1 or 2 comprising a second variable shading system outside the outer enclosure and arranged to shade a variable proportion of the outer surface of the outer enclosure, whereby to provide controlled absorption of incident solar radiation.

4. The growing room of claim 2 or 3, wherein the first and/or second variable shading system comprises a blind assembly, preferably a roller blind assembly.

5. The growing room of any preceding claim, wherein the ventilation openings of the outer enclosure are openable for ventilation to the external atmosphere.

6. The growing room of any preceding claim, wherein the inner enclosure comprises a floor for the controlled growing environment and the floor comprises an underfloor radiant temperature control system.

7. The growing room of claim 7, wherein the underfloor radiant temperature control system is an underfloor radiant cooling system.

8. The growing room of claim 7, wherein the underfloor radiant temperature control system is an underfloor radiant heating system.

9. The growing room of any preceding claim further comprising a condensate collection system for collecting condensate generated within the ventilated cavity and/or the inner enclosure for re-use.

10. The growing room of claim 9, wherein the condensate collection system collects water condensing on the outer surface of the inner enclosure.

11. The growing room of any preceding claim, wherein the outer enclosure is constructed from an outer skin and an inner skin, wherein the inner skin is supported on the interior side of at least one structural member and the outer skin is supported on the exterior side of said at least one structural member and the at least one structural member includes a hole to allow air in the space between the inner and outer skins to flow from one side of the at least one structural member to the other.

12. The growing room of claim 11, wherein the inner skin substantially seals the ventilated cavity from the space between the inner skin and the outer skin.

13. The growing room of any preceding claim, wherein the inner enclosure is suspended from a structural frame located within the ventilated cavity.

14. A network of growing rooms, each growing room as claimed in any of the preceding claims, the network including a plenum for the transmission of carbon dioxide between the controlled growing environments of the growing rooms in the network.

15. A network of growing rooms as claimed in claim 14 further comprising a mushroom house in fluid communication with the growing rooms via the plenum.

16. A network of growing rooms, each growing room for providing a controlled growing environment and comprising an enclosure for containing the controlled growing environment, the enclosure enclosing, in use, a controlled atmosphere for the controlled growing environment, the network including a plenum for the transmission of carbon dioxide between the controlled growing environments of the growing rooms in the network, wherein at least one, but not all, of the growing rooms in the network, is a mushroom house.

17. A network of growing rooms as claimed in any of claims 14 to 16 further including at least one service room, for example a packing house, in fluid communication with the controlled growing environments of the growing rooms, wherein the service room has a roof and the roof is provided with solar panels for providing electrical power to the network.

18. A network of growing rooms as claimed in any of claims 14 to 17, wherein the rooms in the network are connected by corridors which are in fluid communication with the controlled growing environments of the growing rooms.

19. A kit of parts for constructing a growing room as claimed in any of claims 1 to 13.
